(19) United States
(12) Patent Application Publication
(10) Pub. No.: US 2014/0141124 A1
(43) Pub. Date: May 22, 2014

(54) UREA FOOD PELLETS AND ASSOCIATED METHODS

(71) Applicant: ELWHA LLC., Bellevue, WA (US)

(72) Inventors: Jeffrey John Hagen, Plymouth, MN (US); Eric C. Leuthardt, St. Louis, MO (US); Lowell L. Wood, JR., Bellevue, WA (US)

(73) Assignee: Elwha LLC., Bellevue, WA (US)

(21) Appl. No.: 13/679,895

(22) Filed: Nov. 16, 2012

(51) Int. Cl. A23K 1/22

(52) U.S. Cl. CPC A23K 1/22
USPC 426/72; 426/89; 426/93; 426/96

(57) ABSTRACT

A controlled release form of a non-protein nitrogenous feedstock for animals is provided. In certain embodiments, the non-protein nitrogenous feedstock is urea, the animals are ruminants, and the release of the nitrogen is pH-dependent. Processes and methods for manufacturing and administering a non-protein nitrogenous feedstock for animals, as described herein, are also provided.

### TECHNICAL FIELD

The invention relates to a controlled release form of a non-protein nitrogenous feedstuff for animals. Processes and methods for manufacturing and administering a non-protein nitrogenous feedstuff for animals, as described herein, are also provided.

### DETAILED DESCRIPTION

Animal feedstuff routinely includes protein, roughage and carbohydrate components, as well as vitamins, minerals and other supplements. Protein sources provide nitrogen to the animals and are vital components of animal feedstuff. Often, the protein component represents a substantial cost of the feedstuff. Farmers must balance the amount of the nutritive components used in the feed to maximize the yield per unit cost, which depends in part upon the price, quality and nutritional efficiency of each component.

Ruminant animals are able to digest lignocellulosic material that is poorly digested by non-ruminants. Due to the ruminant digestive system, non-protein sources of nitrogen are able to be utilized by ruminants and are transformed into nutritionally effective protein to form body tissue. The ability to use non-protein nitrogen (NPN) as a protein source in ruminant feedstuff is a benefit for feeding such animals.

Ruminant animals have a stomach with four compartments, wherein food is digested. Exemplary ruminant animals include sheep, cattle such as beef cattle and dairy cattle, bison, goats and deer. The first two chambers of a ruminant stomach are the rumen and the reticulum, containing semi-digested contents typically at a pH of between about 5 and 7, or at about 6. Together, these chambers are known as the reticulorumen. The third chamber of a ruminant stomach is the omasum, and the fourth chamber is the abomasum, also known as the true stomach. The contents of the abomasum typically have a pH of between about 2 and 4, or at about 3.

In the reticulorumen, microorganisms including bacteria, protozoa and fungi, ferment and break down the feed ingested by the animal. One of these digestive products is ammonia, which is utilized by the microorganisms for their own growth and which they convert to protein as nutrition for the animal. However, if the ammonia production in the reticulorumen is higher than that absorbed by the resident microorganisms, the excess ammonia may be released into the bloodstream of the animal, causing alkalosis and potentially death.

A desirable feedstuff for animals is a bioavailable form of nitrogen-containing feedstuff, which limits the amount of excess ammonia present in the reticulorumen. Methods and processes for manufacturing and administering such a nitrogenous feedstuff are also desired.

Disclosed herein is a controlled release form of a NPN-containing feedstuff for animals. Methods and processes for manufacturing and administering a non-protein nitrogenous feedstuff for animals are also described. In particular, the controlled release feedstuff may comprise a NPN animal feed ingredient and a controlled release ingredient which releases NPN in response to an acidic environment, such as that found in the abomasum of a ruminant animal.

### I. DEFINITIONS

It is to be understood that the terminology used herein is for the purpose of describing particular embodiments only, and is not intended to limit the scope of the present invention which will be limited only by the appended claims.

Unless defined otherwise, all technical and scientific terms used herein have the meanings that would be commonly understood by one of skill in the art. As used herein, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, a ratio, a pH, and the like, is meant to encompass variations of 50%, 30%, 20%, 10%, 5%, 1% 0.5%, or even 0.1% of the specified amount. All publications, patent applications, patents, and other references mentioned herein are incorporated by reference in their entirety.

The term “non-protein nitrogen” (NPN) refers to any nitrogenous species that provides bioavailable nitrogen to an animal upon the introduction of the species to the intestinal tract of the animal, which is not a protein, peptide, amino acid or mixture thereof. A source of NPN for animal feed is urea, which produces ammonia or ammonium ion to the animal during digestion. Other sources of NPN include, for example, urea, biuret, ammonium acetate, ammonium sulfate, ammonium butyrate, methylene urea, and an ammonium salt of an amino acid. Additional sources include, for example, acetamide, ammonia, butryamide, creatine, creatinine, dicyanoamide, formamide, ethylene urea, isobutanol diurea, lactosyl urea, propionamide, uric acid and urea phosphate. Suitable ammonium salts also include, for example, the acetate, bicarbonate, carbamate, carbonate, chloride, citrate, formate, furmerate, lactate, maleate, phosphate, polyphosphate, propionate, succinate and sulfate ammonium salts, or any other suitable salt.

The term “animal feed ingredient” refers to any compound or composition that is used to nourish an animal. Exemplary animal feed ingredients include, for example, a grain product, a plant protein product, an animal protein product, a vitamin supplement, a mineral supplement, and mixtures thereof. An animal feed ingredient may contain nitrogen.

The term “controlled release ingredient” refers to any compound or composition that is used to regulate the delivery of an item. Exemplary controlled release ingredients include, for example, a liposome, a membrane, a hydrogel, an aldehyde, an acrylic polymer or copolymer, a vinyl polymer or copolymer, an amino acid, and mixtures thereof.

The term “hydrogel” refers to a network of polymer chains which are hydrophilic. Hydrogels are usually highly water absorbent and may be colloidal in nature. Hydrogels may be comprised of, or based on, natural or synthetic polymers or copolymers. Exemplary hydrogels include, for example, a chitosan-based hydrogel, a carboxymethyl-based hydrogel, a carboxymethyl chitosan-based hydrogel, a carboxymethyl scleroglucan-based hydrogel, a chitosan-based hydrogel comprising polyvinyl pyrrolidone, a chitosan-based hydrogel comprising tripolyphosphate, a chitosan-based hydrogel comprising glycidyltrimethylammonium chloride, a chitosan-based hydrogel comprising Ac-poly(amidoamine), and a chitosan-based hydrogel comprising polyacrylamide.

The term “liposome” refers to a vesicle made of a lipid bilayer. A liposome may encapsulate a region of aqueous solution inside a hydrophobic membrane. Exemplary lipids include, for example, cholesterol and phospholipids such as phosphatidic acid, phosphatidyl ethanolamine, phosphatidyl choline, phosphatidyl serine, the phosphoinositides, and the phosphosphingolipids. In an embodiment, a liposome comprises dioleoylphosphotidyl ethanolamine.

The term “majority” refers to at least half of a value. In certain embodiments, a majority is at least about 50%, at least about 60%, at least about 75%, at least about 90%, at least about 95%, about 51%, about 55%, about 60%, about 75%, about 90%, about 95%, no less than about 55%, no less than about 60%, no less than about 75%, no less than about 90%, or no less than about 95% of a value.

The terms “nutritionally useful” and “nutritionally effective” refer to amount of an ingredient or composition that contributes to the nourishment of an animal. The terms “nutritionally useful” and “nutritionally effective” can designate an amount that maintains a desired physiological state, i.e., promotes improvement in an animal's diet. For example, a nutritionally effective or useful amount of an ingredient or composition described herein would be an amount that improves the production of milk, wool or body mass (i.e. meat) in an animal. As is generally understood in the art, nutritionally effective amounts will vary depending on, for example, the specific feed ingredients, ease of their digestion, and the body weight of the animal.

In the context of the present description, the term “binder” refers to a diluent, adjuvant, excipient, stabilizer, vehicle, or any combination thereof, with which an ingredient as described herein may be combined to provide an animal feedstuff, or which may be combined with an animal feedstuff, or ingredient thereof, to aid in preparing the feedstuff for ingestion by an animal For example, a binder may be added to an animal feedstuff, or ingredient thereof, to form a dry block set out for animals to lick, or added to prepare a liquid or paste form appropriate for a liquid lick feeder.

### II. A CONTROLLED RELEASE FEEDSTUFF

Herein is disclosed a feedstuff which delivers NPN to an animal in a controlled manner. In an embodiment, the NPN delivery is regulated by an ingredient of the feedstuff which releases the NPN in an acidic environment, such as is found in the abomasum of a ruminant animal, but does not release it in the reticulorumen portion of the ruminant digestive system.

In an embodiment, the controlled release feedstuff of the present invention comprises two ingredients, those being a non-protein nitrogenous animal feed ingredient and a controlled release ingredient.

In an embodiment, the non-protein nitrogenous animal feed ingredient comprises at least one of the following: a grain product, a plant protein product, an animal protein product, a vitamin supplement, a mineral supplement, and mixtures thereof.

The NPN provides bioavailable nitrogen to the animal when digested, and it is, of course, not a protein. In an embodiment, the NPN is selected from at least one of the following: urea, biuret, ammonium acetate, ammonium sulfate, ammonium butyrate, methylene urea, and an ammonium salt of an amino acid. In a further embodiment, the NPN is urea. Additional sources of NPN include, for example, acetamide, ammonia, butryamide, creatine, creatinine, dicyanoamide, formamide, ethylene urea, isobutanol or isobutane diurea, lactosyl urea, propionamide, uric acid and urea phosphate. Suitable ammonium salts also include, for example, the acetate, bicarbonate, carbamate, carbonate, chloride, citrate, formate, furmerate, lactate, maleate, phosphate, polyphosphate, propionate, succinate and sulfate ammonium salts, or any other suitable salt.

The controlled release ingredient of the feedstuff is used to regulate the delivery of the NPN. The difference between the pH of the reticulorumen (i.e. about neutral pH) and the pH of the abomasum (acidic) provides a route to control the delivery of a nutritionally effective amount of a NPN to a ruminant animal, while limiting the production of potentially toxic ammonia.

Urea, if used in a conventional feedstuff, is digested into ammonia in the reticulorumen of a ruminant animal. Excess ammonia may become toxic to animals, which has limited the use of urea as a NPN source. Recommended levels of urea supplementation of feed for ruminants has been limited to 1% of the total dry weight of the feed, corresponding to 0.3 g/kg of body weight per day.

However, if the urea is not available for digestion in the reticulorumen and instead passes into the omasum and/or the abomasum before being released, the potential for ammonia toxicity may be eliminated and allow for higher amounts of urea to be used in ruminant feedstuff. Incorporating a NPN, such as urea, with an appropriate controlled release ingredient which does not allow the NPN to be exposed or released, and thus digested, until it reaches the acidic pH of the abomasum, may avoid ammonia toxicity.

In certain embodiments, a majority of the non-protein nitrogenous animal feed ingredient is not bioavailable to the reticulorumen upon ingestion. For example, a controlled release ingredient may be used to release the non-protein nitrogenous animal feed ingredient at a rate at an acidic pH that is higher than the rate of release at a neutral or near-neutral pH. In an embodiment, the controlled release ingredient releases the non-protein nitrogenous animal feed ingredient at a rate at a pH of about 3 that is more than twice the rate of release at a pH of about 6. In a further embodiment, the controlled release ingredient releases the non-protein nitrogenous animal feed ingredient at a rate at a pH of about 3 that is more than three times the rate of release at a pH of about 6. In an additional embodiment, the controlled release ingredient releases the non-protein nitrogenous animal feed ingredient at a rate at a pH of about 3 that is more than five times the rate of release at a pH of about 6.

In an embodiment, the controlled release ingredient releases a majority of the non-protein nitrogenous animal feed ingredient at a rate at a pH of about 3 that is more than twice the rate of release at a pH of about 6. In a further embodiment, the controlled release ingredient releases a majority of the non-protein nitrogenous animal feed ingredient at a rate at a pH of about 3 that is more than three times the rate of release at a pH of about 6. In an additional embodiment, the controlled release ingredient releases a majority of the non-protein nitrogenous animal feed ingredient at a rate at a pH of about 3 that is more than five times the rate of release at a pH of about 6.

In a further embodiment, the release of the non-protein nitrogenous animal feed ingredient from the controlled release ingredient occurs at a higher rate at an acidic pH than at a neutral pH. In an additional embodiment, the release of the non-protein nitrogenous animal feed ingredient from the controlled release ingredient occurs at a higher rate at an acidic pH than at a basic pH.

In an embodiment, the release of the non-protein nitrogenous animal feed ingredient from the controlled release ingredient does not occur at an appreciable level when the pH is neutral. In a further embodiment, the release of the non-protein nitrogenous animal feed ingredient from the controlled release ingredient does not occur at an appreciable level when the pH is basic.

The rate of release of the non-protein nitrogenous animal feed ingredient from the feedstuff over time, as regulated by the controlled release ingredient, is referred to as the release profile of the feedstuff. It may be useful for the controlled release ingredient to slowly release the non-protein nitrogenous animal feed ingredient, such as over a 24-hour period, for example, once exposed to a low pH environment. In certain embodiments, it may be useful for the controlled release ingredient to delay the release of the non-protein nitrogenous animal feed ingredient even in, for example, a low pH environment. In other embodiments, it may be useful for the controlled release ingredient to release the non-protein nitrogenous animal feed ingredient immediately upon exposure to, for example, a low pH or acidic environment.

In an embodiment, a release profile of the non-protein nitrogenous animal feed ingredient from the controlled release ingredient is based on the basal pH profile within the gastrointestinal tract of the animal. In another embodiment, a release profile of the non-protein nitrogenous animal feed ingredient from the controlled release ingredient is selected to have a lower release rate within the reticulorumen of the animal than within the abomasum of the animal.

In an embodiment, a release profile of the non-protein nitrogenous animal feed ingredient from the controlled release ingredient has a release rate within the reticulorumen of the animal which is less than about 10% of a release rate within the abomasum of the animal. In a further embodiment, a release profile of the non-protein nitrogenous animal feed ingredient from the controlled release ingredient has a release rate within the reticulorumen of the animal which is less than about 1% of a release rate within the abomasum of the animal. In an additional embodiment, a release profile of the non-protein nitrogenous animal feed ingredient from the controlled release ingredient has a release rate within the reticulorumen of the animal of about 0%.

After passage through the abomasum, digested material flows into the small intestine of the animal. The small intestine has a pH of between about 7 and 8, i.e. a near-neutral environment. In an embodiment, a release profile of the non-protein nitrogenous animal feed ingredient from the controlled release ingredient is selected to have a lower release rate within the intestine of the animal than within the abomasum of the animal. In a further embodiment, a release profile of the non-protein nitrogenous animal feed ingredient from the controlled release ingredient has a release rate within the intestine of the animal which is less than about 10% of a release rate within the abomasum of the animal. In an additional embodiment, a release profile of the non-protein nitrogenous animal feed ingredient from the controlled release ingredient has a release rate within the intestine of the animal which is less than about 1% of a release rate within the abomasum of the animal. In certain embodiments, a release profile of the non-protein nitrogenous animal feed ingredient from the controlled release ingredient has a release rate within the intestine of the animal of about 0%.

There are various controlled release ingredients which may be used to deliver a non-protein nitrogenous animal feed ingredient while maintaining a nutritionally useful level of the ingredient in an animal's digestive system. The controlled release ingredient, for example, may regulate the release of urea from an animal feedstuff. Incorporation of the non-protein nitrogenous animal feed ingredient with the controlled release ingredient may occur via various types of interactions, as detailed herein. These controlled release ingredients may physically or chemically sequester, surround, or encapsulate the non-protein nitrogenous animal feed ingredient. In an embodiment, the controlled release ingredient encapsulates the non-protein nitrogenous animal feed ingredient.

Semipermeable coatings or membranes which surround the non-protein nitrogenous animal feed ingredient may be useful as controlled release ingredients. The coatings may be formed from an organic polymer which allows the non-protein nitrogenous animal feed ingredient to be released via diffusion, or may be formed from a biodegradable polymer which, for example, degrades rapidly in an acidic environment but is stable in a neutral or near-neutral pH. Exemplary polymers include polyurethane and poly(lactic-co-glycolic acid).

Liposomes, which are vesicles made of a lipid bilayer, may be used to regulate the release of non-protein nitrogenous animal feed ingredients. Lipid vesicles may be formed when phospholipids are placed in an aqueous solution and consequently form a bilayer, and the bilayer is then disrupted. The vesicles self-assemble, driven by the amphipathic nature of the phospholipid. A liposome may encapsulate a portion of aqueous solution containing, for example, a hydrophilic ingredient, or it may incorporate lipophilic or hydrophobic ingredients directly into its hydrophobic membrane. Liposomes may be designed to release entrapped material, such as an animal feed ingredient, when exposed to various pH values, based on the composition and amounts of lipids. The release may occur dues to instability of the bilayer, and result in the bilayers' disintegration.

For example, dioleoylphosphatidylethanolamine (DOPE) and cholesteryl hemisuccinate (CHEMS) may be combined in various amounts, including equimolar and at DOPE/CHEMS ratios of 6/4 and 8/2, for pH-dependent release of an animal feed ingredient. Fatty acyl N,N-dimethyl-1-diamino alkyl (ADDA) compounds, such as a fatty acyl N₃,N₃-dimethyl-propyl-1,3-diamine, may also be used for the formation of pH-dependent release.

Successful formation of liposomes containing a material such as a non-protein nitrogenous animal feed ingredient, typically requires analysis of various parameters including the physicochemical characteristics of the material to be entrapped and those of the liposomal ingredients, the nature of the medium in which the lipid vesicles are dispersed, the effective concentration of the entrapped substance, and an evaluation of the unique processes involved during storage and delivery of the liposomes as animal feedstock, such as the optimum size, polydispersity and shelf-life of the vesicles, as well as manufacturing issues such as batch-to-batch reproducibility and large-scale production of efficient liposomal products.

Hydrogels may be used in a similar manner, to incorporate materials such as a non-protein nitrogenous animal feed ingredient for controlled release. Hydrogels contain a network of hydrophilic polymer chains from natural or synthetic polymers or copolymers, or mixtures thereof. These substantially dilute cross-linked systems exhibit no flow and behave like solids when in the steady-state, even though by weight, hydrogels are mostly liquid.

Hydrogels include, for example, certain polysaccharides or derivatized polysaccharides. Carboxymethylcellulose, scleroglucan, alginate and chitosan all contain ionic groups such as carboxylic acids and amines, which change their protonation state in acidic environments, and which may be used to aid in ionic bonding with various animal feed ingredients. For example, chitosan's protonated amine groups lead to an increase in its solubility in acidic environments, and its lack of a positive charge means chitosan is insoluble in neutral and basic environments. Thus, chitosan may maintain its structure in a neutral environment, but may solubilize and degrade in an acidic environment, thereby releasing any incorporated animal feed ingredient.

Hydrogels may also be made from certain amino acid and synthetic polymers. Hydrogels may incorporate more than one type of polymer to form its cross-linked polymeric network, such as a natural polymer and a synthetic polymer, to help optimize release of a material such as a non-protein nitrogenous animal feed ingredient.

Hydrogels have the ability to detect changes of pH, temperature, or the concentration of metabolite in their environments, and release incorporated materials as result of such a change. With judicious selection of the hydrophilic polymers or copolymers used to form the hydrogel, controlled release of an incorporated material can occur, for example, in response to the pH difference found between the reticulorumen and abomasum.

Specifically, a hydrogel formed from poly((2-dimethylamino)ethyl methacrylate-glycidyl methacrylate)-alginate may be useful for pH-dependent release of a non-protein nitrogenous animal feed ingredient. Similarly, a hydrogel made from a copolymer of sodium acrylate and carboxymethylcellulose, combined with sodium alginate, may be useful, as would a hydrogel composed of poly(ethylene glycol) and poly(β-amino ester urethane). Hydrogels comprising poly(vinyl alcohol) and poly[2-(dimethylamino)ethyl methacrylate]; chitosan and polyacrylamide; chitosan and acetyl-poly(amidoamine); N-[(2-hydroxy-3-trimethylammonium)propyl]chitosan chloride and α,β-glycerophosphate; chitosan and tripolyphospate; chitosan, polyvinyl pyrrolidone and glutaraldehyde; carboxymethyl chitosan; and carboxymethyl scleroglucan, may also be useful for the pH-dependent release of a non-protein nitrogenous animal feed ingredient.

Polysaccharides, such as cellulose, or derivatives thereof, may also be used to incorporate a non-protein nitrogenous animal feed ingredient for controlled release. Derivatizing cellulose with carboxymethyl groups bound to some of the hydroxyl groups on the glucose monomers within the polymer, allows for formation of a viscous gel-type product with carboxylic acid groups available for interacting with materials such as an animal feed ingredient. Certain polysaccharides can form hydrogels. These gels are able to incorporate and release materials upon environmental changes, including pH changes. For example, ethylcellulose may be used to coat a non-protein nitrogenous animal feed ingredient.

Other controlled release ingredients include lipid monolayers, such as unilamellar vesicles, or bilayers, and chemical compounds comprising aldehyde groups, each of which may function to incorporate and release materials such as a non-protein nitrogenous animal feed ingredient upon environmental changes, including pH changes. For example, large unilamellar vesicles (LUVs) prepared from cholesteryl hemisuccinate (CHEMS) and N,N-dioleoyl-N,N-dimethylammonium chloride (DODAC) with DODAC/CHEMS molar ratios of 0 to 0.85 may be useful, as would LUVs comprising 3α-[N—(N,N-dimethylaminoethane)-carbamoyl]cholesterol and dioleoylphosphatidic acid (DOPA) in the same molar ratios. The ratios may be tuned or adjusted specifically to match the pH values found in the ruminant digestive system, and may be dependent on the physicochemical nature of the non-protein nitrogenous animal feed ingredient used.

In an embodiment, the controlled release ingredient is selected from at least one of the following: a liposome, a membrane, a hydrogel, an aldehyde, an acrylic polymer or copolymer, a polysaccharide, a vinyl polymer or copolymer, an amino acid, and mixtures thereof.

In a further embodiment, the controlled release ingredient is a liposome. In certain embodiments, the controlled release ingredient is a liposome comprising a phospholipid. In an additional embodiment, the controlled release ingredient is a liposome comprising dioleoylphosphotidyl ethanolamine.

In an embodiment, the controlled release ingredient is a hydrogel. In a further embodiment, the controlled release ingredient is a chitosan-based hydrogel. In certain embodiments, the controlled release ingredient is a carboxymethyl-based hydrogel. In one embodiment, the controlled release ingredient is a carboxymethyl chitosan-based hydrogel. In an embodiment, the controlled release ingredient is a carboxymethyl scleroglucan-based hydrogel. In certain embodiments, the controlled release ingredient is a chitosan-based hydrogel comprising polyvinyl pyrrolidone. In a further embodiment, the controlled release ingredient is a chitosan-based hydrogel comprising tripolyphosphate. In an additional embodiment, the controlled release ingredient is a chitosan-based hydrogel comprising glycidyltrimethylammonium chloride. In an embodiment, the controlled release ingredient is a chitosan-based hydrogel comprising Ac-poly(amidoamine). In certain embodiments, the controlled release ingredient is a chitosan-based hydrogel comprising polyacrylamide.

In an embodiment, the controlled release ingredient is an alginate hydrogel. In a further embodiment, the controlled release ingredient is an alginate hydrogel comprising an acrylate.

In an embodiment, the controlled release ingredient is an amino acid hydrogel. In certain embodiments, the controlled release ingredient is an amino acid hydrogel comprising urethane. In a further embodiment, the controlled release ingredient is an amino acid hydrogel comprising poly(ethylene glycol). In an additional embodiment, the controlled release ingredient is an amino acid hydrogel comprising urethane and poly(ethylene glycol).

In an embodiment, the controlled release ingredient is an poly(vinyl alcohol) hydrogel. In a further embodiment, the controlled release ingredient is an poly(vinyl alcohol) hydrogel comprising an acrylate. In an additional embodiment, the controlled release ingredient is an poly(vinyl alcohol) hydrogel comprising methacrylate.

In an embodiment, the controlled release ingredient is carboxymethylcellulose. In certain embodiments, the controlled release ingredient is a copolymer of carboxymethylcellulose and an acrylate. In a further embodiment, the controlled release ingredient is a copolymer of carboxymethylcellulose and sodium acrylate.

The form or disposition of the feedstuff may vary as necessary, as determined by a skilled artisan. It may be useful for the feedstuff to be provided to the animals along with other feedstuff, such as grain or a source of protein nitrogen. The form may be as a solid, or it may be a liquid.

In an embodiment, the non-protein nitrogenous animal feed ingredient and the controlled release ingredient are disposed as a pellet. In certain embodiments, the pellet comprises at least two different non-protein nitrogenous animal feed ingredients. In an additional embodiment, the feedstuff includes a mixture of pellets wherein different pellets contain different NPN animal feed ingredients, and/or different pH profiles for release of the NPN animal feed ingredient from the controlled release ingredient. In further embodiments, the pellet further comprises a binder.

A plurality of feedstuff may be provided to animals, with varying levels of non-protein nitrogenous animal feed ingredients and/or controlled release ingredients, for example. In an embodiment, the non-protein nitrogenous animal feed ingredient and the controlled release ingredient are disposed as a plurality of pellets. In certain embodiments, the a first pellet comprises a different non-protein nitrogenous animal feed ingredient than a second pellet. In further embodiments, a first pellet comprises a different pH profile for release of the non-protein nitrogenous animal feed ingredient from the controlled release ingredient than a second pellet. In additional embodiments, the feedstuff comprising a plurality of pellets further comprises a binder.

The amount of a non-protein nitrogenous animal food ingredient present in the feedstuff can be any amount consistent with providing a nutritionally effective amount of NPN to the animal. For example, a non-protein nitrogenous animal food ingredient may be present in the feedstuff in an amount ranging from about 1% to about 99% by weight, based on the total weight of the feedstuff. In an embodiment, the non-protein nitrogenous animal food ingredient may be present in the feedstuff in an amount ranging from about 5% to about 90% by weight, an amount ranging from about 20% to about 80% by weight, or in an amount at least about 5%, at least about 10%, or at least about 20% by weight. Alternatively, the non-protein nitrogenous animal food ingredient may be present in the feedstuff in an amount no greater than about 80%, no greater than about 60%, no greater than about 40%, or no greater than about 20% by weight.

The amount of controlled release ingredient present in the feedstuff can be any amount consistent with providing a nutritionally effective amount of NPN to the animal. For example, the controlled release ingredient may be present in the feedstuff in an amount ranging from about 1% to about 99% by weight, based on the total weight of the feedstuff. In an embodiment, the controlled release ingredient may be present in the feedstuff in an amount ranging from about 5% to about 90% by weight, an amount ranging from about 20% to about 80% by weight, in an amount at least about 5%, at least about 10%, or at least about 20% by weight. Alternatively, the controlled release ingredient may be present in the feedstuff in an amount no greater than about 80%, no greater than about 60%, no greater than about 40%, or no greater than about 20% by weight.

It is contemplated that other components may be added to the animal feedstuff, to provide nutritional, medicinal or other benefits to the animal. For example, protein sources of nitrogen may be added, fats, emulsifiers, vitamins or minerals, or any binder deemed suitable by a skilled artisan. Such binders include, for example, lignin, wheat powder, molasses, starch, gelatin, carboxymethylcellulose, guar gum, casien or gum arabic.

### III. PROCESSES FOR MANUFACTURING AN ANIMAL FEEDSTUFF

Processes for manufacturing a controlled release feedstuff for animals as described above are also provided herein. In an embodiment, a process for the manufacture of a controlled release feedstuff for animals comprises mixing a non-protein nitrogenous animal feed ingredient with a controlled release ingredient, and forming an animal feed supplement product, wherein the controlled release ingredient releases the non-protein nitrogenous animal feed ingredient at a rate at a pH of about 3 that is more than twice the rate of release at a pH of about 6.

In an additional embodiment, a process for the manufacture of a controlled release feedstuff for animals comprises mixing a non-protein nitrogenous animal feed ingredient with a controlled release ingredient, and forming an animal feed supplement product, wherein the controlled release ingredient releases a majority of the non-protein nitrogenous animal feed ingredient at a rate at a pH of about 3 that is more than twice the rate of release at a pH of about 6.

In an embodiment, a process for the manufacture of a controlled release feedstuff for animals is provided for animals which are ruminant animals. In certain embodiments, the animals are sheep. In an embodiment, the animals are cattle, including beef and dairy cattle. In a further embodiment, the animals are bison. In certain embodiments, the animals are goats. In an additional embodiment, the animals are deer.

In an embodiment, a process for the manufacture of a controlled release feedstuff for animals is provided wherein the non-protein nitrogenous animal feed ingredient comprises at least one of the following: a grain product, a plant protein product, an animal protein product, a vitamin supplement, a mineral supplement, and mixtures thereof. In certain embodiments, the non-protein nitrogenous animal feed ingredient is selected from at least one of the following: urea, biuret, ammonium acetate, ammonium sulfate, ammonium butyrate, methylene urea, and an ammonium salt of an amino acid. In an additional embodiment, the non-protein nitrogenous animal feed ingredient is urea.

In an embodiment, a process for the manufacture of a controlled release feedstuff for animals is provided wherein the controlled release ingredient is selected from at least one of the following: a liposome, a membrane, a hydrogel, an aldehyde, an acrylic polymer or copolymer, a polysaccharide, a vinyl polymer or copolymer, an amino acid, and mixtures thereof. In certain embodiments, the controlled release ingredient is a liposome. In an embodiment, the controlled release ingredient is a liposome comprising a phospholipid. In an additional embodiment, the controlled release ingredient is a liposome comprising dioleoylphosphotidyl ethanolamine.

In further embodiments, the controlled release ingredient is a hydrogel. In certain embodiments, the controlled release ingredient is a chitosan-based hydrogel. In additional embodiments, the controlled release ingredient is a carboxymethyl-based hydrogel. In an embodiment, the controlled release ingredient is a carboxymethyl chitosan-based hydrogel. In additional embodiments, the controlled release ingredient is a carboxymethyl scleroglucan-based hydrogel. In an embodiment, the controlled release ingredient is a chitosan-based hydrogel comprising polyvinyl pyrrolidone. In further embodiments, the controlled release ingredient is a chitosan-based hydrogel comprising tripolyphosphate. In an embodiment, the controlled release ingredient is a chitosan-based hydrogel comprising glycidyltrimethylammonium chloride. In additional embodiments, the controlled release ingredient is a chitosan-based hydrogel comprising Ac-poly(amidoamine). In a further additional embodiment, the controlled release ingredient is a chitosan-based hydrogel comprising polyacrylamide.

In an embodiment, a process for the manufacture of a controlled release feedstuff for animals is provided wherein the controlled release ingredient is carboxymethylcellulose. In an additional embodiment, the controlled release ingredient is a copolymer of carboxymethylcellulose and an acrylate. In a further embodiment, the controlled release ingredient is a copolymer of carboxymethylcellulose and sodium acrylate. In certain embodiments, the controlled release ingredient is an alginate hydrogel. In some embodiments, the controlled release ingredient is an alginate hydrogel comprising an acrylate. In alternative embodiments, the controlled release ingredient is an amino acid hydrogel. In additional further embodiments, the controlled release ingredient is an amino acid hydrogel comprising urethane. In still further embodiments, the controlled release ingredient is an amino acid hydrogel comprising poly(ethylene glycol).

In an embodiment, the controlled release ingredient is an amino acid hydrogel comprising urethane and poly(ethylene glycol). In an additional embodiment, the controlled release ingredient is an poly(vinyl alcohol) hydrogel. In certain embodiments, the controlled release ingredient is an poly(vinyl alcohol) hydrogel comprising an acrylate. In further embodiments, the controlled release ingredient is an poly(vinyl alcohol) hydrogel comprising methacrylate.

In an embodiment, a process for the manufacture of a controlled release feedstuff for animals is provided wherein the controlled release ingredient encapsulates the animal feed ingredient.

In an embodiment, a process for the manufacture of a controlled release feedstuff for animals is provided wherein the release of the non-protein nitrogenous animal feed ingredient from the controlled release ingredient occurs at a higher rate at an acidic pH than at a neutral pH. In certain embodiments, the release of the non-protein nitrogenous animal feed ingredient from the controlled release ingredient occurs at a higher rate at an acidic pH than at a basic pH. In further embodiments, the release of the non-protein nitrogenous animal feed ingredient from the controlled release ingredient does not occur at an appreciable level when the pH is neutral. In additional embodiments, the release of the non-protein nitrogenous animal feed ingredient from the controlled release ingredient does not occur at an appreciable level when the pH is basic.

In an embodiment, a process for the manufacture of a controlled release feedstuff for animals is provided wherein a release profile of the non-protein nitrogenous animal feed ingredient from the controlled release ingredient is based on the basal pH profile within the gastrointestinal tract of the animal. In certain embodiments, a release profile of the non-protein nitrogenous animal feed ingredient from the controlled release ingredient is selected to have a lower release rate within the reticulorumen of the animal than within the abomasum of the animal. In further embodiments, a release profile of non-protein nitrogenous animal feed ingredient from the controlled release ingredient has a release rate within the reticulorumen of the animal which is less than about 10% of a release rate within the abomasum of the animal. In additional embodiments, a release profile of the non-protein nitrogenous animal feed ingredient from the controlled release ingredient has a release rate within the reticulorumen of the animal which is less than about 1% of a release rate within the abomasum of the animal. In an embodiment, a release profile of the non-protein nitrogenous animal feed ingredient from the controlled release ingredient has a release rate within the reticulorumen of the animal of about 0%.

In an embodiment, a process for the manufacture of a controlled release feedstuff for animals is provided wherein a release profile of the non-protein nitrogenous animal feed ingredient from the controlled release ingredient is selected to have a lower release rate within the intestine of the animal than within the abomasum of the animal. In further embodiments, a release profile of the non-protein nitrogenous animal feed ingredient from the controlled release ingredient has a release rate within the intestine of the animal which is less than about 10% of a release rate within the abomasum of the animal. In certain embodiments, a release profile of the non-protein nitrogenous animal feed ingredient from the controlled release ingredient has a release rate within the intestine of the animal which is less than about 1% of a release rate within the abomasum of the animal. In further embodiments, a release profile of the non-protein nitrogenous animal feed ingredient from the controlled release ingredient has a release rate within the intestine of the animal of about 0%.

The animal feed supplement product may be a solid or a liquid, and may be formed into any suitable shape or size for the specific animal to be fed, as determined by a skilled artisan. For example, the animal feed supplement product may be a small solid pellet for ingestion as a whole, or it may be in the form of a dry block set out for the animals to lick. Alternatively, it may be in a liquid or paste form appropriate for a liquid lick feeder. A binder or multiple binders may be added to the animal feed supplement product to aid in forming the product for ingestion by an animal. The product may be formed with any apparatus deemed appropriate by a skilled artisan, including, for example, a pellet mill, an extruder, a briquetting apparatus, or any of a variety of granulators (e.g., a fluidized-bed, flow type, or rotary-plate type).

In an embodiment, forming an animal feed supplement product comprises disposing the non-protein nitrogenous animal feed ingredient and the controlled release ingredient as a pellet. In an embodiment, the pellet comprises at least two different non-protein nitrogenous animal feed ingredients. In an additional embodiment, the pellet further comprises a binder.

In certain embodiments, forming an animal feed supplement product comprises disposing the non-protein nitrogenous animal feed ingredient and the controlled release ingredient as a plurality of pellets. In further embodiments, the plurality of pellets includes a first pellet comprising a different non-protein nitrogenous animal feed ingredient than a second pellet. In an embodiment, the plurality of pellets includes a first pellet comprising a different pH profile for release of the non-protein nitrogenous animal feed ingredient from the controlled release ingredient than a second pellet. In additional embodiments, forming an animal feed supplement product comprises disposing the non-protein nitrogenous animal feed ingredient and the controlled release ingredient as a mixture of pellets wherein different pellets contain different NPN animal feed ingredients and/or two different pH profiles for release of the non-protein nitrogenous animal feed ingredient from the controlled release ingredient. In an additional embodiment, the plurality of pellets further comprise a binder.

In an additional embodiment, the pellet has a length along its major axis of between about 0.5 mm and about 5.0 cm. In a further embodiment, the pellet has a length along its major axis of between about 1.0 mm and about 4.0 cm. In an embodiment, the pellet has a length along its major axis of between about 10 mm and about 2.0 cm. In certain embodiments, the pellet has a length along its major axis of less than about 1 mm, less than about 0.1 mm, or less than about 0.01 mm; such small pellets may be advantageous for delivery in liquid medium (e.g., as an aqueous slurry), or after being pressed together into a solid block.

### IV. METHODS FOR ADMINISTERING AN ANIMAL FOOD ADDITIVE

Methods for administering a food additive to animals, comprising the feedstuff described above, are presented. In an embodiment, a method of administering a food additive to animals comprises feeding the animals a controlled release feedstuff, wherein the feedstuff comprises a non-protein nitrogenous animal feed ingredient and a controlled release ingredient, wherein the controlled release ingredient releases the animal feed ingredient at a rate at a pH of about 3 that is more than twice the rate of release at a pH of about 6.

In an additional embodiment, a method of administering a food additive to animals comprises feeding the animals a controlled release feedstuff, wherein the feedstuff comprises a non-protein nitrogenous animal feed ingredient and a controlled release ingredient, wherein the controlled release ingredient releases a majority of the animal feed ingredient at a rate at a pH of about 3 that is more than twice the rate of release at a pH of about 6.

In an embodiment, a method of administering a food additive to animals is provided for animals which are ruminant animals. In certain embodiments, the animals are sheep. In an embodiment, the animals are cattle, including beef and dairy cattle. In a further embodiment, the animals are bison. In an embodiment, the animals are goats. In an additional embodiment, the animals are deer.

In an embodiment, a method of administering a food additive to animals is provided wherein the non-protein nitrogenous animal feed ingredient comprises at least one of the following: a grain product, a plant protein product, an animal protein product, a vitamin supplement, a mineral supplement, and mixtures thereof. In certain embodiments, the non-protein nitrogenous animal feed ingredient is selected from at least one of the following: urea, biuret, ammonium acetate, ammonium sulfate, ammonium butyrate, methylene urea, and an ammonium salt of an amino acid. In an additional embodiment, the non-protein nitrogenous animal feed ingredient is urea.

In an embodiment, a method of administering a food additive to animals is provided wherein the controlled release ingredient is selected from at least one of the following: a liposome, a membrane, a hydrogel, an aldehyde, an acrylic polymer or copolymer, a polysaccharide, a vinyl polymer or copolymer, an amino acid, and mixtures thereof. In certain embodiments, the controlled release ingredient is a liposome. In an embodiment, the controlled release ingredient is a liposome comprising a phospholipid. In an additional embodiment, the controlled release ingredient is a liposome comprising dioleoylphosphotidyl ethanolamine.

In further embodiments, the controlled release ingredient is a hydrogel. In certain embodiments, the controlled release ingredient is a chitosan-based hydrogel. In additional embodiments, the controlled release ingredient is a carboxymethyl-based hydrogel. In an embodiment, the controlled release ingredient is a carboxymethyl chitosan-based hydrogel. In additional embodiments, the controlled release ingredient is a carboxymethyl scleroglucan-based hydrogel. In an embodiment, the controlled release ingredient is a chitosan-based hydrogel comprising polyvinyl pyrrolidone. In further embodiments, the controlled release ingredient is a chitosan-based hydrogel comprising tripolyphosphate. In an embodiment, the controlled release ingredient is a chitosan-based hydrogel comprising glycidyltrimethylammonium chloride. In additional embodiments, the controlled release ingredient is a chitosan-based hydrogel comprising Ac-poly(amidoamine). In a further additional embodiment, the controlled release ingredient is a chitosan-based hydrogel comprising polyacrylamide.

In an embodiment, a method of administering a food additive to animals is provided wherein the controlled release ingredient is carboxymethylcellulose. In an additional embodiment, the controlled release ingredient is a copolymer of carboxymethylcellulose and an acrylate. In a further embodiment, the controlled release ingredient is a copolymer of carboxymethylcellulose and sodium acrylate. In certain embodiments, the controlled release ingredient is an alginate hydrogel. In some embodiments, the controlled release ingredient is an alginate hydrogel comprising an acrylate. In alternative embodiments, the controlled release ingredient is an amino acid hydrogel. In additional further embodiments, the controlled release ingredient is an amino acid hydrogel comprising urethane. In still further embodiments, the controlled release ingredient is an amino acid hydrogel comprising poly(ethylene glycol).

In an embodiment, the controlled release ingredient is an amino acid hydrogel comprising urethane and poly(ethylene glycol). In an additional embodiment, the controlled release ingredient is an poly(vinyl alcohol) hydrogel. In certain embodiments, the controlled release ingredient is an poly(vinyl alcohol) hydrogel comprising an acrylate. In further embodiments, the controlled release ingredient is an poly(vinyl alcohol) hydrogel comprising methacrylate.

In an embodiment, a method of administering a food additive to animals is provided wherein the controlled release ingredient encapsulates the animal feed ingredient.

In an embodiment, a method of administering a food additive to animals is provided wherein the release of the non-protein nitrogenous animal feed ingredient from the controlled release ingredient occurs at a higher rate at an acidic pH than at a neutral pH. In certain embodiments, the release of the non-protein nitrogenous animal feed ingredient from the controlled release ingredient occurs at a higher rate at an acidic pH than at a basic pH. In further embodiments, the release of the non-protein nitrogenous animal feed ingredient from the controlled release ingredient does not occur at an appreciable level when the pH is neutral. In additional embodiments, the release of the non-protein nitrogenous animal feed ingredient from the controlled release ingredient does not occur at an appreciable level when the pH is basic.

In an embodiment, a method of administering a food additive to animals is provided wherein a release profile of the non-protein nitrogenous animal feed ingredient from the controlled release ingredient is based on the basal pH profile within the gastrointestinal tract of the animal. In certain embodiments, a release profile of the non-protein nitrogenous animal feed ingredient from the controlled release ingredient is selected to have a lower release rate within the reticulorumen of the animal than within the abomasum of the animal. In further embodiments, a release profile of non-protein nitrogenous animal feed ingredient from the controlled release ingredient has a release rate within the reticulorumen of the animal which is less than about 10% of a release rate within the abomasum of the animal. In additional embodiments, a release profile of the non-protein nitrogenous animal feed ingredient from the controlled release ingredient has a release rate within the reticulorumen of the animal which is less than about 1% of a release rate within the abomasum of the animal. In an embodiment, a release profile of the non-protein nitrogenous animal feed ingredient from the controlled release ingredient has a release rate within the reticulorumen of the animal of about 0%.

In an embodiment, a method of administering a food additive to animals is provided wherein a release profile of the non-protein nitrogenous animal feed ingredient from the controlled release ingredient is selected to have a lower release rate within the intestine of the animal than within the abomasum of the animal. In further embodiments, a release profile of the non-protein nitrogenous animal feed ingredient from the controlled release ingredient has a release rate within the intestine of the animal which is less than about 10% of a release rate within the abomasum of the animal. In certain embodiments, a release profile of the non-protein nitrogenous animal feed ingredient from the controlled release ingredient has a release rate within the intestine of the animal which is less than about 1% of a release rate within the abomasum of the animal. In further embodiments, a release profile of the non-protein nitrogenous animal feed ingredient from the controlled release ingredient has a release rate within the intestine of the animal of about 0%.

The method for administering the food additive may be, for example, via whole ingestion of a small solid pellet, via licking of a dry block (e.g., formed from a mixture of binder and pellets), or it may be via ingestion of a slurry containing pellets. Alternatively, it may be via ingestion of a liquid or paste form appropriate for a liquid lick feeder. A binder or multiple binders may be added to the food additive to aid in administering the food additive to an animal. The method for administering the food additive may be via any suitable method specific to the animal to be fed, as determined by a skilled artisan.

In an embodiment, a method of administering a food additive to animals is provided wherein the non-protein nitrogenous animal feed ingredient and the controlled release ingredient are disposed as a pellet. In certain embodiments, a method of administering a food additive to animals is provided wherein the non-protein nitrogenous animal feed ingredient and the controlled release ingredient are disposed as a pellet which comprises at least two different non-protein nitrogenous animal feed ingredients. In a further embodiment, a method of administering a food additive to animals is provided wherein the non-protein nitrogenous animal feed ingredient and the controlled release ingredient are disposed as a pellet, wherein the pellet further comprises a binder.

A plurality of feedstuff may be provided to animals, with varying levels of non-protein nitrogenous animal feed ingredients and/or controlled release ingredients, for example. In certain embodiments, a method of administering a food additive to animals includes disposing the non-protein nitrogenous animal feed ingredient and the controlled release ingredient as a plurality of pellets. In further embodiments, a method of administering a food additive to animals is provided wherein the non-protein nitrogenous animal feed ingredient and the controlled release ingredient are disposed as a plurality of pellets, wherein a first pellet comprises a different non-protein nitrogenous animal feed ingredient than a second pellet. In an additional embodiment, a first pellet comprises a different pH profile for release of the non-protein nitrogenous animal feed ingredient from the controlled release ingredient than a second pellet. In additional embodiments, a method of administering a food additive to animals includes disposing the non-protein nitrogenous animal feed ingredient and the controlled release ingredient as a plurality of pellets, wherein different pellets contain different NPN animal feed ingredients and/or two different pH profiles for release of the non-protein nitrogenous animal feed ingredient from the controlled release ingredient. In a further embodiment, the plurality of pellets further comprise a binder. In certain embodiments, the plurality of pellets are further disposed as a slurry within a liquid medium.

In an embodiment, the method of administering the food additive may further comprise feeding the animals an additional controlled release feedstuff, wherein the additional feedstuff comprises a non-protein nitrogenous animal feed ingredient, and a controlled release ingredient, wherein the controlled release ingredient releases the non-protein nitrogenous animal feed ingredient at a rate at a pH of about three that is more than twice the rate of release at a pH of about six.

In certain embodiments, the method of administering the food additive may further comprise feeding the animals an additional controlled release feedstuff, wherein the additional feedstuff comprises a non-protein nitrogenous animal feed ingredient, and a controlled release ingredient, wherein the controlled release ingredient releases a majority of the non-protein nitrogenous animal feed ingredient at a rate at a pH of about three that is more than twice the rate of release at a pH of about six.

As may be appreciated by those skilled in the art, the present invention is amenable for modification and variation without departing from the spirit and scope of the invention as hereinafter claimed.

1. A controlled release feedstuff for animals, comprising
a non-protein nitrogenous animal feed ingredient, and
a controlled release ingredient,
wherein the controlled release ingredient releases the animal feed ingredient at a rate at a pH of about three that is more than twice the rate of release at a pH of about six.

2. The feedstuff of claim 1, wherein the animals are ruminant animals.

3.-9. (canceled)

10. The feedstuff of claim 1, wherein the non-protein nitrogenous animal feed ingredient comprises at least one of the following: a grain product, a plant protein product, an animal protein product, a vitamin supplement, a mineral supplement, and mixtures thereof.

11. The feedstuff of claim 1, wherein the non-protein nitrogenous animal feed ingredient is selected from at least one of the following: urea, biuret, ammonium acetate, ammonium sulfate, ammonium butyrate, methylene urea, and an ammonium salt of an amino acid.

12. The feedstuff of claim 1, wherein the non-protein nitrogenous animal feed ingredient is urea.

13. The feedstuff of claim 1, wherein the controlled release ingredient is selected from at least one of the following: a liposome, a membrane, a hydrogel, an aldehyde, an acrylic polymer or copolymer, a polysaccharide, a vinyl polymer or copolymer, an amino acid, and mixtures thereof.

14. The feedstuff of claim 1, wherein the controlled release ingredient is a liposome.

15.-16. (canceled)

17. The feedstuff of claim 1, wherein the controlled release ingredient is a hydrogel.

18. The feedstuff of claim 1, wherein the controlled release ingredient is a chitosan-based hydrogel.

19. The feedstuff of claim 1, wherein the controlled release ingredient is a carboxymethyl-based hydrogel.

20.-26. (canceled)

27. The feedstuff of claim 1, wherein the controlled release ingredient is carboyxymethylcellulose.

28.-29. (canceled)

30. The feedstuff of claim 1, wherein the controlled release ingredient is an alginate hydrogel.

31. (canceled)

32. The feedstuff of claim 1, wherein the controlled release ingredient is an amino acid hydrogel.

33.-35. (canceled)

36. The feedstuff of claim 1, wherein the controlled release ingredient is an poly(vinyl alcohol) hydrogel.

37.-38. (canceled)

39. The feedstuff of claim 1, wherein the controlled release ingredient encapsulates the animal feed ingredient.

40. The feedstuff of claim 1, wherein the release of the non-protein nitrogenous animal feed ingredient from the controlled release ingredient occurs at a higher rate at an acidic pH than at a neutral pH.

41. The feedstuff of claim 1, wherein the release of the non-protein nitrogenous animal feed ingredient from the controlled release ingredient occurs at a higher rate at an acidic pH than at a basic pH.

42. The feedstuff of claim 1, wherein the release of the non-protein nitrogenous animal feed ingredient from the controlled release ingredient does not occur at an appreciable level when the pH is neutral.

43. The feedstuff of claim 1, wherein the release of the non-protein nitrogenous animal feed ingredient from the controlled release ingredient does not occur at an appreciable level when the pH is basic.

44. The feedstuff of claim 1, wherein a release profile of the non-protein nitrogenous animal feed ingredient from the controlled release ingredient is based on the basal pH profile within the gastrointestinal tract of the animal.

45. The feedstuff of claim 1, wherein a release profile of the non-protein nitrogenous animal feed ingredient from the controlled release ingredient is selected to have a lower release rate within the reticulorumen of the animal than within the abomasum of the animal.

46.-47. (canceled)

48. The feedstuff of claim 1, wherein a release profile of the non-protein nitrogenous animal feed ingredient from the controlled release ingredient has a release rate within the reticulorumen of the animal of about 0%.

49. The feedstuff of claim 1, wherein a release profile of the non-protein nitrogenous animal feed ingredient from the controlled release ingredient is selected to have a lower release rate within the intestine of the animal than within the abomasum of the animal.

50.-51. (canceled)

52. The feedstuff of claim 1, wherein a release profile of the non-protein nitrogenous animal feed ingredient from the controlled release ingredient has a release rate within the intestine of the animal of about 0%.

53. The feedstuff of claim 1, wherein the non-protein nitrogenous animal feed ingredient and the controlled release ingredient are disposed as a pellet.

54. The feedstuff of claim 53, wherein the pellet comprises at least two different non-protein nitrogenous animal feed ingredients.

55. The feedstuff of claim 53, comprising a plurality of pellets.

56. The feedstuff of claim 55, wherein a first pellet comprises a different non-protein nitrogenous animal feed ingredient than a second pellet.

57. The feedstuff of claim 55, wherein a first pellet comprises a different pH profile for release of the non-protein nitrogenous animal feed ingredient from the controlled release ingredient than a second pellet.

58. The feedstuff of claim 55, further comprising a binder.
